(19) United States
(12) Patent Application Publication
(10) Pub. No.: US 2025/0100210 A1
(43) Pub. Date: Mar. 27, 2025

(54) A method for fused deposition modelling of a 3D item

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 18/730,236

(22) PCT Filed: Jan. 16, 2023
(86) PCT No.: PCT/EP2023/050853

§ 371 Date: Jul. 18, 2024

(30) Foreign Application Priority Data
Jan. 20, 2022 (EP) 22152356.6

(51) Int. Cl. B29C 64/118; B22F 10/22; B33Y 10/00; B33Y 70/10; B33Y 80/00

(52) U.S. Cl. CPC B29C 64/118; B22F 10/22; B33Y 10/00; B33Y 70/10; B33Y 80/00

(57) ABSTRACT

The present invention relates to a method for producing, by means of fused deposition modelling, a 3D item that has the ability to dissipate relatively large amounts of heat. The method uses a 3D printable material (1) that comprises a 3D printable shell material (3) and a 3D printable core material (2). The 3D item (7) comprises a plurality of layers (6) of a 3D printed material (1′), each layer (6) having a layer shell comprising a 3D printed shell material (3′) and at least partly enclosing a layer core comprising a 3D printed core material (2′). The method comprises the steps of (i) feeding the 3D printable material (1) into a nozzle of a 3D printer, and (ii) layer-wise depositing the 3D printable material (1) to provide the 3D item (7). The 3D printable core material (2) comprises a metal having a core melting temperature, and the 3D printable shell material (3) comprises a thermoplastic material having at least one of a shell glass transition temperature and a shell melting temperature. The nozzle has a nozzle temperature that is equal to or higher than the core melting temperature and equal to or higher than each of the at least one of the shell glass transition temperature and the shell melting temperature.

### FIELD OF THE INVENTION

The present invention relates to a method for manufacturing a 3D item by means of fused deposition modelling.

### BACKGROUND OF THE INVENTION

Fused deposition modelling (FDM) is one of the most frequently used techniques for producing objects based on additive manufacturing (3D printing). FDM works on an “additive” principle by applying plastic material in layers. In particular, FDM may be used for printing luminaires.

Since electrical components of a luminaire oftentimes generate a considerable amount of heat, implementation of heat-dissipating elements, such as heatsinks, is required.

Graphite-filled polymers have been used for production of heat sinks. However, thermal conductivity of such polymers remains to be around 5 W/m K, being insufficient for spreading and dissipating large amount of heat.

Another alternative is using metal printing. However, the method and the materials remain too expensive to be used in lighting applications. Therefore, currently available heatsinks used in 3D printed luminaires are based on flat sheets or extruded profiles of aluminum, which are cut to desired dimensions. This means that such parts need to be ordered in advance and stored until they are used, thus resulting in rather high costs and causing delays in delivery times contrary to what is claimed in producing luminaires based on additive manufacturing.

Therefore, it is desirable to provide an improved method and material for 3D printing that remedies the shortcomings of the current methods, and that enables simple and cost-efficient printing of 3D items that have the ability to dissipate relatively large amounts of heat.

WO-2021/104920 discloses a method for producing a 3D item by means of fused deposition modelling. The method uses a 3D printable material having a core material and a shell material. The core material comprises a thermoplastic material and an additive material in the form of metal particles.

### SUMMARY OF THE INVENTION

It is an object of the present invention to provide a method for manufacturing, by means of fused deposition modelling, a 3D item that has the ability to dissipate relatively large amounts of heat.

The method according to the invention uses a 3D printable material that comprises a 3D printable shell material and a 3D printable core material. The 3D item comprises a plurality of layers of a 3D printed material, each layer (of the plurality of layers) having a layer shell comprising a 3D printed shell material and at least partly enclosing a layer core comprising a 3D printed core material.

The method comprises the steps of (i) feeding the 3D printable material into a nozzle of a 3D printer, and (ii) layer-wise depositing the 3D printable material (1) to provide the 3D item.

The 3D printable core material comprises a metal having a core melting temperature, and the 3D printable shell material comprises a thermoplastic material having at least one of a shell glass transition temperature and a shell melting temperature.

The nozzle has a nozzle temperature. The nozzle temperature is equal to or higher than the core melting temperature and equal to or higher than each of the at least one of the shell glass transition temperature and the shell melting temperature.

In other words, the method comprises the steps of (a) providing a 3D printable material comprising a 3D printable core material and a 3D printable shell material, wherein the 3D printable core material comprises a metal having a core melting temperature (T_{c}), and wherein the 3D printable shell material comprises a thermoplastic material having at least one of a shell glass transition temperature (T_{g}) and a shell melting temperature (Tₛ), (b) feeding the 3D printable material into a nozzle of a 3D printer, the nozzle having a nozzle temperature Tₙ being equal to or higher than the core melting temperature (T_{c}) and equal to or higher than each of the at least one of the shell glass transition temperature (T_{g}) and the shell melting temperature (Tₛ), (c) melting the 3D printable material in the nozzle, and (d) printing the 3D item by layer-wise deposition of the 3D printable material to provide the 3D item comprising a plurality of core-shell layers of a 3D printed material, wherein each core-shell layer comprises a layer core comprising a 3D printed core material and a layer shell comprising a 3D printed shell material, wherein the layer shell at least partly encloses the layer core.

The term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. The term “extrudate” may be used to define the 3D printable material downstream of the printer head, but not yet deposited. In fact, the extrudate comprises 3D printable material, as the material is not yet deposited. Upon deposition of the 3D printable material or extrudate, the material is thus indicated as 3D printed material. Normally, the 3D printable material, the extrudate and 3D printed material are the same material, as the material upstream of the printer head, downstream of the printer head, and when deposited, is substantially the same material.

Herein, the term “3D printable material” may also be indicated as “printable material”. The term “printable material” may refer to a single type of printable material but may also refer to a plurality of different printable materials. The term “printed material” may refer to a single type of printed material but may also refer to a plurality of different printed materials.

The term “metal” in the context of the present invention implies a material that conducts electricity and heat relatively well and is malleable and/or ductile. A metal may be a chemical element or an alloy.

The metal has a melting temperature of 275° C. or less, such as 250° C. or less, or 200° C. or less. Also, the metal may comprise indium, tin, bismuth, gallium, or combinations thereof.

The core melting temperature T_{c} of the 3D printable core material may be substantially the same as the melting temperature of the metal comprised in the 3D printable core material. Thus, when the metal is indium, T_{c} may be approximately 157° C., while when the metal is tin, T_{c} may be approximately 232° C.

When the 3D printable core material is an alloy comprising at least a first metal and a second metal, it may have a melting trajectory from a first core melting temperature T_{c1} corresponding to the melting temperature of the first metal, to a second core melting temperature T_{c2} corresponding to the melting temperature of the second metal. The second core melting temperature T_{c2} may be higher than the nozzle temperature Tₙ. This allows the 3D printable core material to not become fully molten, but instead remains solid but very soft. The term “soft” implies a measure of the resistance to localized plastic deformation induced by either mechanical indentation or abrasion. This offers the advantage of 3D printable core material maintaining its structural integrity.

The 3D printable core material may further comprise metal particles in order improve metal properties of the 3D printable core material. The metal particles may have a thermal conductivity being equal to or higher than 200 W/m K, such that thermal management provided by the 3D printed core material is improved. In particular, the metal particles may comprise aluminum, copper, or combination thereof. Indeed, the melting temperature Tₚ of the metal particles should be higher than the nozzle temperature Tₙ, such that the particles remain their structural integrity when passing the printer head. In other words, the 3D printable core material may comprise a metal which may be liquified in the nozzle while the metal particles in the liquefied metal will stay a solid when passing through the nozzle.

The term “thermoplastic material” may refer to a plastic polymer material that becomes pliable or moldable at a certain elevated temperature and solidifies upon cooling. The thermoplastic material may refer to a blend of different polymers but may in embodiments also refer to essentially a single polymer type with different polymer chain lengths. Hence, the terms “thermoplastic material” may refer to a single type of polymers but may also refer to a plurality of different polymers. The shell melting temperature of the 3D printable shell material may be substantially the same as the melting temperature of the thermoplastic material comprised in the 3D printable shell material.

The thermoplastic material may be selected from polycarbonate (PC), acrylate-styrene-acrylonitrile (ASA), acrylonitrile-butadiene-styrene (ABS), polypropylene (PP), high density polyethylene (HDPE), polymethyl methacrylate (PMMA), polyethylene terephthalate (PET), polyethylene furanoate (PEF) or mixtures thereof. In particular, the thermoplastic material may comprise thermoplastic biopolymer or a recycled polymeric material. Such an embodiment offers the advantage of providing an environmentally friendly 3D item. By the term “thermoplastic biopolymer” is meant a polymer originating from biomass resources such as cellulose, lignin, and chitin. Such a polymer may require chemical and physical modification techniques in order to induce thermoplasticity. Modification techniques focus on masking the hydroxyl groups to disrupt dense hydrogen bonding and so enable polymer chain mobility upon heating. Thus, introduction of long alkyl chains into the polymer backbone effectively improves the thermoplastic processing of natural polymers.

In general, a thermoplastic material may have a glass transition temperature T_{g} and/or a melting temperature Tₘ. If the thermoplastic material is a blend of a first thermoplastic material and a second thermoplastic material, the glass transition temperature T_{g} and/or the melting temperature Tₘ of the first thermoplastic material may be same as or different from the glass transition temperature T_{g} and/or the melting temperature Tₘ of the second thermoplastic material.

The glass transition temperature is different from the melting temperature. Melting is a transition which occurs in crystalline polymers, and it occurs when the polymer chains fall out of their crystal structures to become a disordered liquid. The glass transition is a transition which occurs for amorphous polymers, that is, polymers whose chains are not arranged in ordered crystals, but are just strewn around in any fashion, even though they are in the solid state. Polymers can be amorphous, essentially having a glass transition temperature and not a melting temperature or they can be (semi) crystalline, in general having both a glass transition temperature and a melting temperature, with the latter typically being larger than the former. The glass transition temperature and the melting temperature may be determined with differential scanning calorimetry.

The 3D printable material will be heated by the 3D printer before it leaves the nozzle to a temperature of at least the glass transition temperature T_{g}, and in general at least the melting temperature Tₘ. Hence, the printer head action may comprise heating the 3D printable material above the glass transition, or above the melting temperature.

The shell melting temperature Tₛ may be higher than the core melting temperature T_{c}, thus offering the advantage of facilitated processability of the 3D printable material.

The 3D printable material may further comprise a barrier layer being arranged between the 3D printable core material and the 3D printable shell material. When such a barrier layer is present, mixing between the 3D printable core material and the 3D printable shell material is minimized or eliminated. In particular, the barrier layer may comprise a thermoplastic material having a barrier melting temperature T_{b}, wherein the nozzle temperature Tₙ is lower than the barrier melting temperature T_{b}, thus providing a barrier layer having high reliability.

The 3D printable material may include one or more additives, for example up to a volume percentage of about 60%, such as up to a volume percentage of about 30%, or up to a volume percentage of 20%, of the additives relative to the total volume of the thermoplastic material and additives.

The additive may be selected from a group consisting of antioxidants, heat stabilizers, light stabilizers, ultraviolet light stabilizers, ultraviolet light absorbing additives, near infrared light absorbing additives, infrared light absorbing additives, plasticizers, lubricants, release agents, antistatic agents, anti-fog agents, antimicrobial agents, colorants, laser marking additives, surface effect additives, radiation stabilizers, flame retardants, and anti-drip agents. The additive may have useful properties selected from optical properties, electrical properties, thermal properties, and mechanical properties.

The 3D printable material, i.e., the 3D printable core material and the 3D printable shell material, may be provided as two separate materials (for example in the form of filaments) being fed to the 3D printer from different supplying devices. Alternatively, the 3D printed material may be a single filament comprising a core comprising 3D printable core material and a shell comprising 3D printable shell material, wherein the shell at least partly encloses the core.

The core may be applied in a continuous manner along the longitudinal extension of the filament. By the term “continuous” is understood as comprising at least one single piece having a length being greater than 10 cm.

Alternatively, the core may be applied in a non-continuous manner along the longitudinal extension of the filament. Such an embodiment provides the advantage of being cost-efficient since the amount of rather expensive metal is minimized.

A filament that can be used in a method as described above comprises a filament core and a filament shell, wherein the filament shell at least partly encloses the filament core, wherein the filament shell comprises a thermoplastic material having at least one of a shell glass transition temperature and a shell melting temperature, and wherein the core comprises a metal having a core melting temperature.

The filament may have a diameter D, wherein the thickness M of the 3D printable shell material may be from 50 to 95%, such as from 60 to 90%, or from 70 to 85%, or from 75 to 80% of the diameter D.

In other words, the 3D printable shell material may be rather thick, thus minimizing the amount of the more expensive core material. At the same time, the amount of core material should be sufficient to provide required thermal management provided by the 3D item.

The printable material is printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform. Instead of the term “receiver item” also the term “substrate” may be used.

Therefore, the phrase “printing on a substrate” and similar phrases include amongst others directly printing on the substrate, or printing on a coating on the substrate or printing on 3D printed material earlier printed on the substrate.

Layer by layer printable material is deposited, by which the 3D item is generated during the printing stage. The 3D item may show a characteristic ribbed structure originating from the deposited filaments. However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include one or more of polishing, coating, adding a functional component, and cross-linking. Post-processing may include smoothening the ribbed structures, which may lead to an essentially smooth surface. Post-processing may include cross-linking of the thermoplastic material. This may result in fewer or no thermoplastic properties of the material.

A 3D item that has been manufactured with the method of the present invention comprises a plurality of layers of 3D printed material, each layer (of the plurality of layers) being a core-shell layer of a 3D printed material comprising a layer core comprising 3D printed core material comprising a metal; and a layer shell comprising a 3D printed shell material comprising a thermoplastic material, wherein the layer shell at least partly encloses the layer core. The 3D item may be a heat sink configured to provide heat sinking for heat generated by an electrical component.

The 3D printed shell may fully enclose the core (in cross-sectional view). Alternatively, the shell may only enclose the core at areas that will become the exterior of the 3D item. Therefore, no shell may be present between cores of adjacent layers, i.e., cores of the adjacent layers may be in contact with each other. Such an embodiment provides the advantage of efficient heat transport. Further, core-shell layers may be aligned.

In a 3D item that has been manufactured with the method of the present invention, the 3D printed core-shell layers may have a width W_{L} and a height H_{L}, wherein W_{L}/H_{L}>1.2, such as W_{L}/H_{L}>1.5, or W_{L}/H_{L}>1.8, or W_{L}/H_{L}>2. Such a ratio may be advantageous in order to maintain structural integrity of the 3D item.

The layer core of the core-shell layer of 3D printed material may have a diameter D1, while the layer shell of the core-shell layer of 3D printed material may have a thickness Tₛ, wherein Tₛ<0.1·D1.

The core-shell layer may be printed with a core-shell nozzle and may be obtained from a core-shell filament.

The 3D item may comprise a plurality of layers on top of each other, i.e., a layer stack. The width W_{L} and height H_{L} of individually 3D printed layers may be selected from the range of 100 to 5000 μm, such as from the range of 200 to 2500 μm, with the height in general being smaller than the width. For instance, the ratio of height and width may be equal to or smaller than 0.8, such as equal to or smaller than 0.6. It should be noted that the layer width W_{L} and/or layer height H_{L} of each layer may be same as or different from the layer width W_{L} and/or layer height H_{L} of the other layers. The 3D item may comprise at least 5 layers, like at least 8 layers, such as at least 10 layers.

The 3D item may further comprise a coating. The coating may comprise several layers and may be arranged for improving aesthetical appearance, providing additional UV resistance, and preventing penetration of fluid and/or gas. If the 3D item of the present invention is intended for outdoor use, the 3D item may comprise an herbicide or a pesticide in order to prevent growth of algae and other biological species on 3D item, which otherwise may lead to deterioration of the outer layer of the 3D item and also negatively affect the aesthetical appearance. The 3D item may be self-cleaning and/or may comprise a substance that facilitates cleaning.

A 3D item that has been manufactured with the method of the present invention may be used as a component of a lighting device. In such a lighting device, the 3D item may be configured as one or more of (i) at least part of a lighting device housing, (ii) at least part of a wall of a lighting chamber, and (iii) an optical element. The lighting device may comprise a light source, such as a LED light source, for example a printed circuit comprising one or more LEDs.

### BRIEF DESCRIPTION OF THE DRAWINGS

Embodiments of the invention will now be described by way of example with reference to the accompanying drawings, of which:

FIG. 1 depicts a cross-section of a filament of a 3D printable material;

FIGS. 1A and 1B show a cross-section of a 3D item comprising three core-shell layers;

FIG. 2 illustrates a cross-section of the filament wherein the core of the filament comprises metal particles;

FIG. 3 shows a cross-section of a filament a 3D printable material;

FIG. 4 depicts the 3D printable material in the form of two separate filaments supplied to a printer head.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

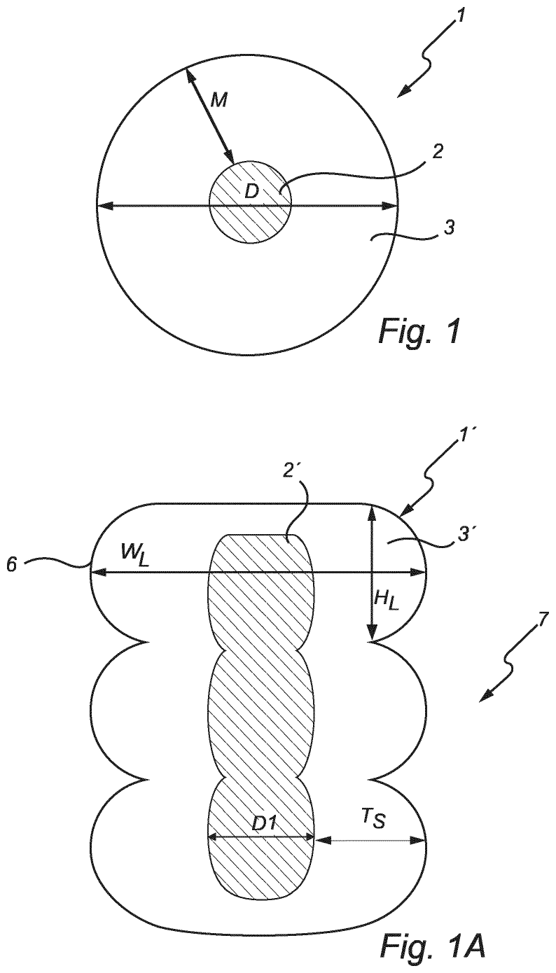

FIG. 1 depicts a 3D printable material 1 in the form of a single filament. The 3D printable material 1 comprises a 3D printable core material 2 and a 3D printable shell material 3, wherein the 3D printable core material 2 comprises a metal having a core melting temperature T_{c}, and wherein the 3D printable shell material 3 comprises a thermoplastic material having a shell melting temperature Tₛ.

As mentioned above, the 3D printable material 1 is fed into a nozzle of the 3D printer, the nozzle having a nozzle temperature Tₙ being equal to or higher than Tₛ and T_{c}. The 3D printable material 1 is molten in the nozzle.

The 3D item 7 is printed by layer-wise deposition of the 3D printable material 1 to provide the 3D item 7 comprising a core-shell layer of 3D printed material 1′, wherein the 3D printed material 1′ comprises a core comprising 3D printed core material 2′ and a shell comprising 3D printed shell material 3′, wherein the shell at least partly encloses the core.

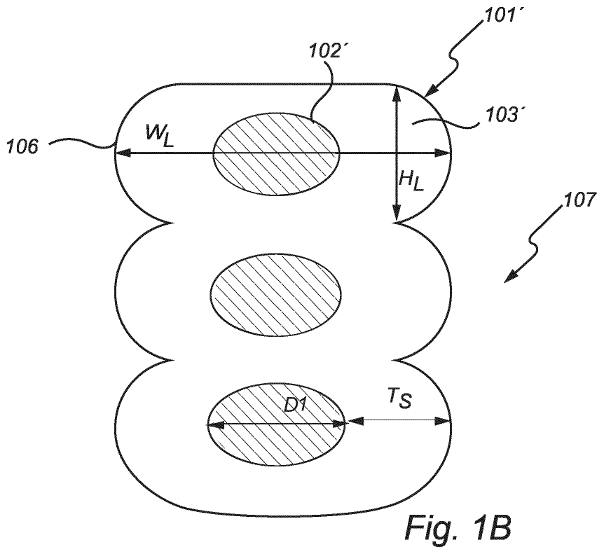

The 3D printable core material 202 shown in FIG. 2 further comprises metal particles 204 in order improve metal properties of the 3D printable core material 202. The metal particles 204 may have a thermal conductivity being equal to or higher than 200 W/m K, such that thermal management provided by the 3D printed core material 202 is improved. In particular, the metal particles may comprise aluminum, copper, or combination thereof. Indeed, the melting temperature Tₚ of the metal particles 204 should be higher than the nozzle temperature Tₙ, such that the particles remain its structural integrity when passing the printer head.

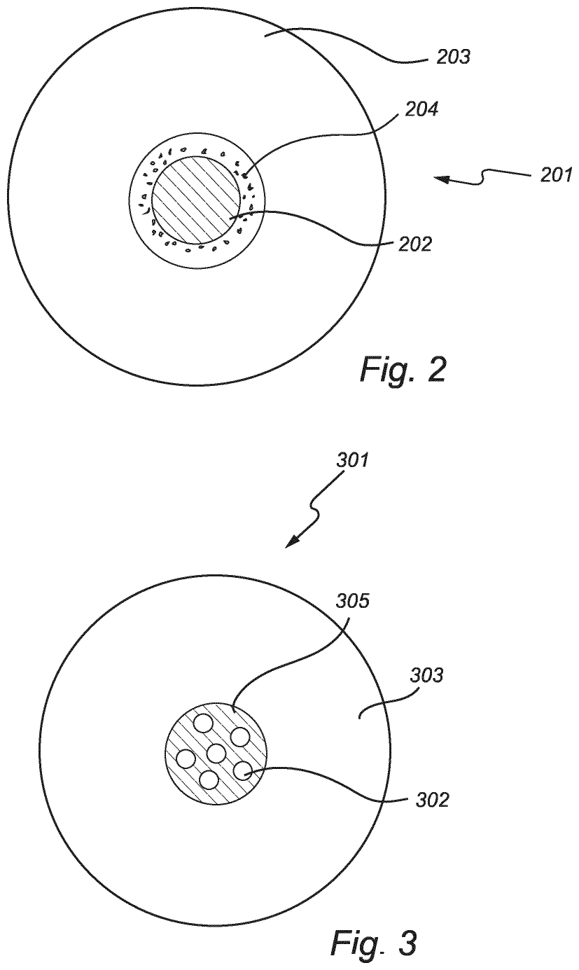

The 3D printable material 301 shown in FIG. 3 further comprises a barrier layer 305 being arranged between the 3D printable core material 302 and the 3D printable shell material 303. When such a barrier layer 305 is present, mixing between the 3D printable core material 302 and the 3D printable shell material 303 is minimized or eliminated. In particular, the barrier layer 305 may comprise a thermoplastic material having a barrier melting temperature T_{b}, wherein the nozzle temperature Tₙ is lower than the barrier melting temperature T_{b}, thus providing a barrier layer 305 having high reliability.

The filament may have a diameter D, wherein the thickness M of the 3D printable shell material may be from 50 to 95%, such as 60 to 90%, or 70 to 85%, or 75 to 80% of the diameter D, as may be seen in FIG. 1.

In other words, the 3D printable shell material 3 may be rather thick, thus minimizing the amount of the more expensive core material 2. At the same time, the amount of core material 2 should be sufficient to provide required thermal management provided by the 3D item 7.

As shown in FIG. 1A, a 3D item 7 comprising a plurality of layers 6 of 3D printed material 1′, wherein the layers 6 are core-shell layers of 3D printed material 1′ comprising a core comprising 3D printed core material 2′ comprising a metal; and a shell comprising 3D printed shell material 3′ comprising thermoplastic material, wherein the shell at least partly encloses the core. As mentioned above, the 3D item 7 may be a heat sink configured to provide heatsinking for heat generated by an electrical component.

As is evident from FIG. 1A, the shell only encloses the core at areas that will become the exterior of the 3D item 7 using this method. Therefore, no shell is present between cores of adjacent layers 6, i.e., cores of the adjacent layers are in contact with each other. This provides the advantage of efficient heat transport. Further, core-shell layers 6 are aligned.

Another embodiment of the 3D item 107 is shown in FIG. 1B. The 3D item 107 comprising a plurality of layers 106 of 3D printed material 101′, wherein the layers 106 are core-shell layers of 3D printed material 101′ comprising a core comprising 3D printed core material 102′ comprising a metal; and a shell comprising 3D printed shell material 103′ comprising thermoplastic material, wherein the shell at least partly encloses the core. As mentioned above, the 3D item 107 may be a heat sink configured to provide heatsinking for heat generated by an electrical component.

As is evident from FIG. 1B, the shell completely encloses the core at each layer 106. Therefore, shell is present between cores of adjacent layers 106, i.e., cores of the adjacent layers are not in contact with each other. Such an embodiment provides the advantage of minimized amount of the 3D printed core material, thus reducing manufacturing costs. Further, core-shell layers 106 are aligned.

The 3D printed core-shell layer 6 has a width W_{L} and a height H_{L}, wherein W_{L}/H_{L}>1.2, such as W_{L}/H_{L}>1.5, or W_{L}/H_{L}>1.8, or W_{L}/H_{L}>2. Such a ratio may be advantageous in order to maintain structural integrity of the 3D item 107.

The core of the core-shell layer of 3D printed material may have a diameter D1, while the shell of the core-shell layer of 3D printed material may have a thickness Tₛ, wherein Tₛ<0.1·D1.

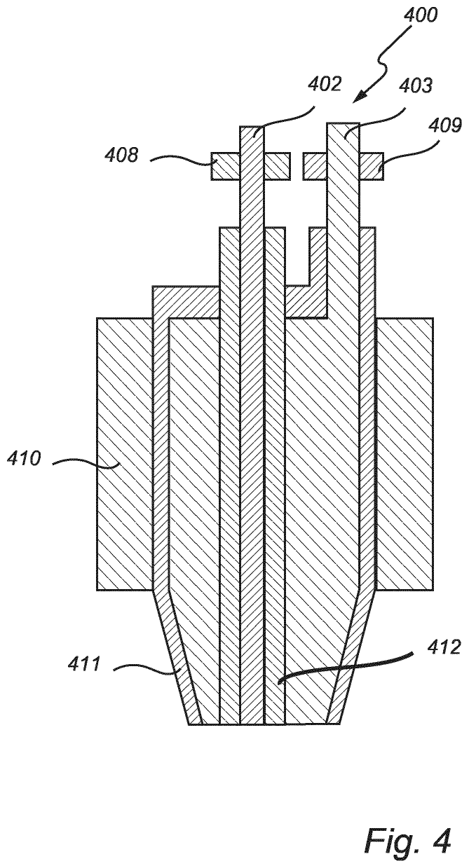

As mentioned above, the 3D printable material, i.e., the 3D printable core material and the 3D printable shell material, may be provided as two separate filaments being fed to the 3D printer from different supplying devices. Such an embodiment is shown in FIG. 4, depicting a printer head 400, to which the 3D printable core material 402 is supplied as a separate filament by a first supplying device 408, and the 3D printable shell material 403 is supplied as a separate filament by a second supplying device 409. The 3D printable core material 402 comprises a metal having a core melting temperature T_{c}, and the 3D printable shell material 403 comprises a thermoplastic material having a shell melting temperature Tₛ.

The nozzle of the printer head 400 comprises two heating elements 410, an outer duct 411 and an inner duct 412. The nozzle has a nozzle temperature Tₙ provided by the heating elements and being equal to or higher than Tₛ and T_{c}. As may be seen in FIG. 4, the 3D printable core material 402 is supplied through the inner duct 412, while the 3D printable shell material 403 is supplied through the outer duct 411. When the 3D printable material leaves the printer head 400, a core-shell layer 406 is formed. Thus, a layer-wise application of the 3D printable material provides the 3D item 7 comprising core-shell layers 406.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention. While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for producing a 3D item by means of fused deposition modelling,
wherein the method uses a 3D printable material that comprises a 3D printable shell material and a 3D printable core material,
wherein the 3D item comprises a plurality of layers of a 3D printed material each layer having a layer shell comprising a 3D printed shell material and at least partly enclosing a layer core comprising a 3D printed core material,
wherein the method comprises the steps of feeding the 3D printable material into a nozzle of a 3D printer, and layer-wise depositing the 3D printable material to provide the 3D item,
wherein the 3D printable core material comprises a metal having a core melting temperature of 275° C. or less, and the 3D printable shell material comprises a thermoplastic material having at least one of a shell glass transition temperature and a shell melting temperature,
wherein the nozzle has a nozzle temperature, and
wherein the nozzle temperature is equal to or higher than the core melting temperature and equal to or higher than each of the at least one of the shell glass transition temperature and the shell melting temperature.

2. The method according to claim 1, wherein the 3D printable material is a filament having a filament shell comprising the 3D printable shell material and at least partly enclosing a filament core comprising the 3D printable core material.

3. The method according to claim 2, wherein the filament core is applied in a non-continuous manner along the longitudinal extension of the filament.

4. The method according to claim 1, wherein the shell melting temperature Tₛ is higher than the core melting temperature T_{c}.

5. The method according to claim 1, wherein the metal is indium, tin, bismuth, gallium, or a combination thereof.

6. The method according to claim 1, wherein the metal is an alloy having a melting trajectory from a first core melting temperature T_{c1} to a second core melting temperature T_{c2}.

7. The method according to claim 6, wherein the second core melting temperature T_{c2} is higher than the nozzle temperature Tₙ.

8. The method according to claim 2, wherein the 3D printable material further comprises a barrier layer being arranged between the filament core and the filament shell.

9. The method according to claim 8, wherein the barrier layer comprises a thermoplastic material having a barrier melting temperature T_{b}, and wherein the nozzle temperature Tₙ is lower than the barrier melting temperature T_{b}.

10. The method according to claim 1, wherein the 3D printable core material comprises metal particles.

11. The method according to claim 10, wherein the metal particles have a thermal conductivity being equal to or higher than 200 W/mK.

12. A 3D item comprising a plurality of layers of a 3D printed material, each layer having a layer shell comprising a 3D printed shell material and at least partly enclosing a layer core comprising a 3D printed core material, wherein the 3D printed shell material comprises a thermoplastic material, and wherein the 3D printed core material comprises a metal having a melting temperature of 275° C. or less.

13. A lighting device comprising a 3D item according to claim 12, wherein the 3D item is configured as one or more of at least part of a lighting device housing, at least part of a wall of a lighting chamber, and an optical element.
